(19) United States
(12) Patent Application Publication
(10) Pub. No.: US 2026/0287426 A1
(43) Pub. Date: Sep. 24, 2026

(54) SPECTROMETER WITH MAGNIFICATION

(71) Applicant: BAE Systems Space & Mission Systems Inc., Broomfield, CO (US)

(72) Inventor: Thomas Ulrich Kampe, Fort Collins, CO (US)

(73) Assignee: BAE Systems Space & Mission Systems Inc., Broomfield, CO (US)

(21) Appl. No.: 19/563,277

(22) Filed: Mar. 11, 2026

Related U.S. Application Data
(60) Provisional application No. 63/774,872, filed on Mar. 20, 2025.

(51) Int. Cl. G01J 3/28; G01J 3/14; G01J 3/18

(52) U.S. Cl. CPC G01J 3/2823; G01J 3/14; G01J 3/18

(57) ABSTRACT

A longwave infrared imaging spectrometer is provided. The spectrometer includes a lens system that magnifies light within the spectrometer. The magnification internal to the spectrometer enables the use of a wider entrance slit for a given pixel pitch of a detector, which increases optical throughput as compared to designs requiring narrower entrance slits, while maintaining a high spectral resolution. The magnification applied within the spectrometer can be any value greater than 1.0.

### CROSS-REFERENCE TO RELATED APPLICATION

This application claims the benefit of U.S. Provisional Patent Application Ser. No. 63/774,872, filed Mar. 20, 2025, the entire disclosure of which is hereby incorporated herein by reference.

### FIELD

Systems and methods for providing a spectrometer with magnification for improved optical throughput are provided. The spectrometer with magnification can be configured as a longwave infrared spectrometer.

### BACKGROUND

Spectrometers are useful in a large number of applications. Imaging spectrometers are instruments that can provide spectrally resolved images of an object or a scene. For example, spectrometers carried by satellites can provide information about the vertical distribution of atmospheric moisture, winds, temperature, and the presence of gases in the atmosphere. Spectrometers can be implemented as camera-like devices, in which light diffracted by a grating is focused onto a detector or focal plane array having a two-dimensional array of light sensitive elements or pixels. In many applications, information at infrared wavelengths, which are longer than light at visible wavelengths, is of particular importance.

To help enable increasingly high spectral coverage and resolution, detectors featuring large format focal plane arrays with an ever increasing number of pixels, and a corresponding ever decreasing pixel size, have been developed. For example, focal plane arrays that can detect light at longwave infrared wavelengths and that have arrays of 4000×4000 pixels, disposed at a 10 μm pixel pitch, are available. In most implementations, spectrometers operate at Nyquist or critical resolution, where the spectrometer entrance slit width is equivalent to a distance spanned by 2-3 pixels at the focal plane array.

Accordingly, as the pixel size of the detector decreases, there is a commensurate decrease in the width of the spectrometer entrance slit. This allows the spectrometer to have high spectral resolution. However, as the width of the entrance slit becomes comparable to the wavelength of light at the longer operational wavelengths of longwave infrared spectrometers, a large amount of light is diffracted from the central core of the beam, and becomes stray light that does not reach the focal plane array. As a result, the optical throughput of the spectrometer is decreased, adversely affecting the signal-to-noise performance of the spectrometer.

Accordingly, it would be desirable to provide a longwave infrared spectrometer capable of providing improved spectral resolution and optical throughput.

### SUMMARY

Embodiments of the present disclosure are directed to providing a longwave infrared spectrometer having high spectral resolution, and high optical throughput. A spectrometer as disclosed herein incorporates optical elements that provide a magnification ratio of greater than 1:1, and thus is referred to herein as a magnifying spectrometer. More particularly, a magnifying spectrometer as disclosed herein includes an entrance slit, a lens system having a first set of elements and a second set of elements, a diffraction element, and a detector. The combined effect of the first and second sets of elements of the lens system is to magnify light input to the magnifying spectrometer before that light is focused onto the detector. In accordance with embodiments of the present disclosure, the magnifying spectrometer is an imaging spectrometer in which the detector is a two-dimensional focal plane array.

Light can be input to the magnifying spectrometer by a telescope or other objective optical system. Light collected by the telescope is passed through the entrance slit, which is located at the focal point of the telescope. After passing through the entrance slit, the light can be passed through the first set of elements of the lens system, to the diffraction element. The light collected by the telescope and passed through the first set of elements of the lens system operates to reimage the entrance pupil onto the diffraction element. Light diffracted by the diffraction element is then passed through the second set of elements of the lens system to the detector. In accordance with embodiments of the present disclosure, the first and second lens systems operate to magnify the light by an amount greater than one.

Additional features and advantages of embodiments of the present disclosure will become more readily apparent from the following description, particularly when taken together with the accompanying drawings.

### BRIEF DESCRIPTION OF THE DRAWINGS

FIG. 1 depicts an optical sensor system incorporating an imaging spectrometer in an example operating scenario;

FIG. 2 illustrates components of an optical sensor system incorporating a telescope and a spectrometer in accordance with the prior art;

FIG. 3 illustrates components of a spectrometer in accordance with the prior art;

FIG. 4 illustrates components of an optical sensor system incorporating a telescope and a magnifying spectrometer in accordance with embodiments of the present disclosure;

FIG. 5 illustrates components of a magnifying spectrometer in accordance with embodiments of the present disclosure;

FIGS. 6A-6B depict the irradiance on a surface behind the entrance slit of comparative examples of spectrometers;

FIGS. 6C-6T illustrate variations in illumination due to differences in a width of the entrance slit; and

FIG. 7 is a flow chart illustrating aspects of a method for obtaining spectrally resolved images in accordance with embodiments of the present disclosure.

### DETAILED DESCRIPTION

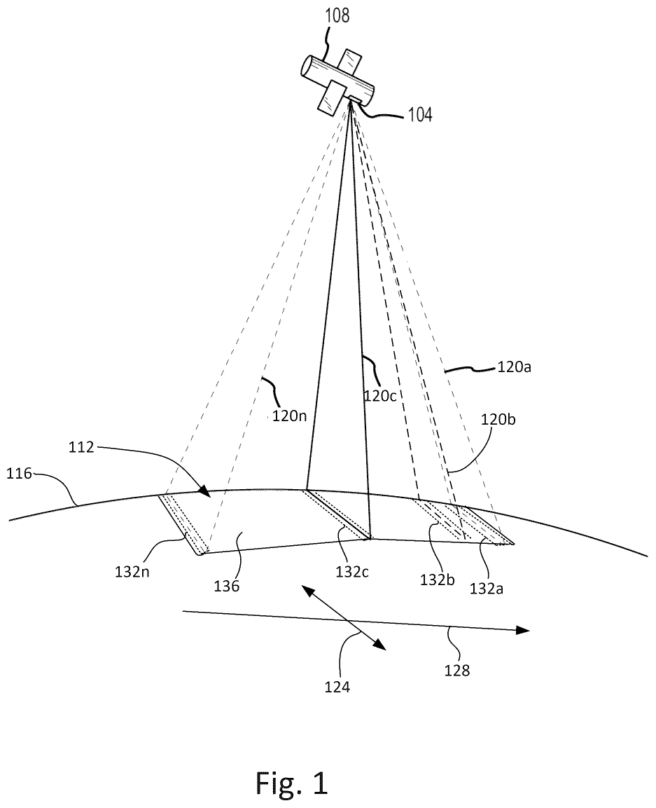

FIG. 1 depicts an optical sensor system 104 incorporating an imaging spectrometer that is mounted to a platform 108. The platform 108 can be in the form of a satellite, as depicted in this example, such as a geostationary or low-Earth orbiting satellite. Other examples of platforms 108 include an aircraft, a ship, a terrestrial vehicle, or a fixed structure. In general, the platform 108 functions to position the optical sensor system 104 such that a portion of an object or area of interest 112, such as an area of the surface of the Earth 116 or a portion of the Earth's atmosphere, is encompassed by a field of view 120 of the optical sensor system 104, where the field of view 120 is defined by span or range of angles over which light can be collected at any one moment in time. As can be appreciated by one of skill in the art after consideration of the present disclosure, the field of view 120 of an optical sensor system 104 that includes an imaging spectrometer is typically in the form of a narrow slice from which light from different locations or points on the object or within the area of interest 112 is collected. As discussed in greater detail elsewhere herein, the light from the different locations within the field of view 120 is directed to different rows (or columns) of pixels included in a detector, providing a spatial context for the collected light. In addition, for each row (or column) of spatial information, different wavelengths of light separated from one another by dispersion of the light within the spectrometer are directed to different columns (or rows) of pixels included in the detector. By orienting the field of view 120 such that the spatial information is collected in a cross track direction 124 (i.e. along a line that is transverse to an along track direction 128), and by taking a series of closely spaced images 132a-n as the field of view 120a-n is moved in the along track direction 128, for instance by moving the platform 108 and/or scanning the field of view 120, a two-dimensional image 136 of a scene encompassing the object or area of interest can be constructed. The spectral information collected from the different locations within the scene or area of interest can be represented by producing different instances of the two-dimensional image 136 for different spectrally resolved wavelengths or ranges of wavelengths.

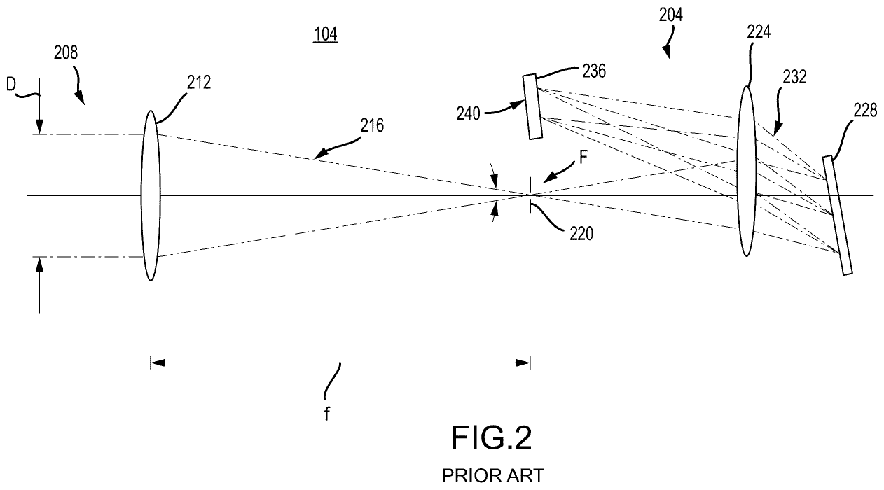

An optical sensor system 104 incorporating an example of a prior art spectrometer 204 and an associated objective optic or telescope 208 is depicted in FIG. 2. As can be appreciated by one of skill in the art, a telescope 208 has an objective lens system 212 that can be characterized by an aperture stop dimension or entrance pupil diameter D and a focal length f. In this example, light 216 collected by the telescope 208 (hereinafter referred to as collected light 216) is focused by the objective lens system 212 to the focal point F, where an entrance slit 220 of the prior art spectrometer 204 is located. A spectrometer lens system 224 receives the collected light 216 that has passed through the entrance slit 220, and focuses that light onto a diffraction or dispersing element 228. Light dispersed or diffracted by the dispersing element 228, hereinafter referred to as diffracted or dispersed light 232 is then passed back through the spectrometer lens system 224, which focuses the dispersed light 232 onto a focal plane array 236 of a detector 240. In such a configuration, the collected light 216 received through the entrance slit 220 of the prior art spectrometer 204 traverses the same optical elements of the spectrometer lens system 224 as does the dispersed light 232. As a result, there is no magnification of the light 216 or 232 within the prior art spectrometer 204 itself. As can be appreciated by one of skill in the art after consideration of the present disclosure, components of the dispersed light 232 that originated as collected light 216 from different locations in the cross track direction 124 within the field of view 120 of the optical sensor system 104 will be incident on different rows (or columns) of pixels of the focal plane array 236, and light of different wavelengths will be incident on different columns (or rows) of pixels of the focal plane array 236.

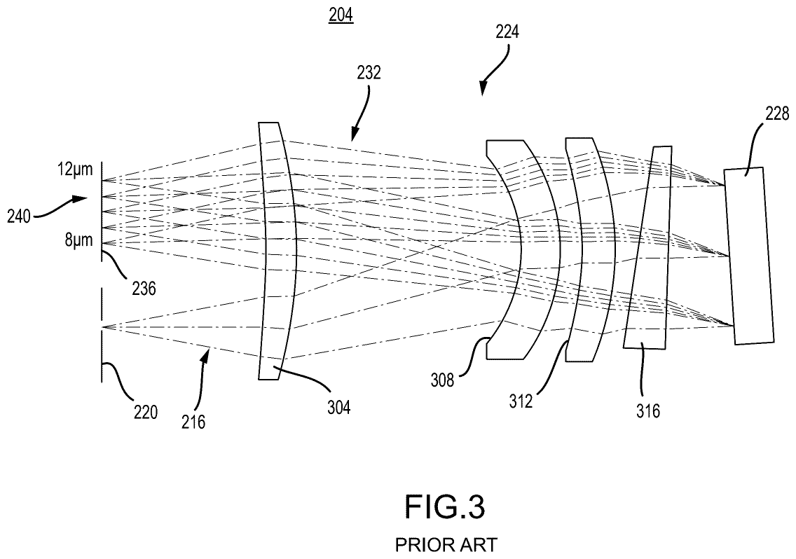

The prior art spectrometer 204 is depicted in additional detail in FIG. 3. As shown, the spectrometer lens system 224 can include multiple elements. For instance, the spectrometer lens system 224 can include a first lens 304, a second lens 308, a third lens 312, and a compensating prism 316. The collected light 216 passed through the entrance slit 220 is received by the first lens 304, the second lens 308, the third lens 312, and the compensating prism 316, in that order, and is thereby focused onto the dispersing element 228. The collected light 216 is dispersed or diffracted by the dispersing element 228 and the resulting dispersed light 232 is passed back through the elements of the spectrometer lens system 224, with the dispersed light 232 being passed to the compensating prism 316, the third lens 312, the second lens 308, and the first lens 304, in that order, and is thereby focused onto the focal plane array 236 of the detector 240.

As an example of a configuration of an optical sensor system 104 including a prior art spectrometer 204, the telescope 208 has an entrance pupil diameter of 240 mm and an objective lens system 212 having a focal length of 659 mm, and is configured to produce a reimaged pupil diameter of about 39 mm at the dispersing element 228, thereby providing a telescope 208 magnification of about 6×. The entrance slit 220 has a length of 39 mm and a width of 0.025 mm. The spectrometer lens system 224 is configured to provide 1:1 magnification (i.e. no magnification of the collected 216 or dispersed light 232 occurs within the prior art spectrometer 204). Accordingly, the image of the entrance slit 220 at the focal plane array 236 has dimensions of about 39 mm by 0.025 mm. This 1:1 symmetry helps to cancel aberrations in the re-imaging optics, while presenting the dispersing element 228 with the geometry most favorable for dispersion, efficiency, and anamorphic scale change. However, when the width of the entrance slit 220 is comparable to the wavelength or wavelengths of the light passed to the detector 240, a large amount of the collected light 216 is diffracted by the entrance slit 220 and is then essentially stray light that does not reach any of the pixels of the focal plane array 236 of the detector 240. As diffraction is inversely proportional to the width of the entrance slit 220, increasing the width of the entrance slit 220 would reduce the amount of light diffracted from the central core of the beam of collected light 216 and increase the amount of light transmitted to the pixels of the focal plane array 236 of the detector 240. However, in the conventional configuration, with the system at a 1:1 magnification, an increase in the width of the entrance slit 220 results in an equivalent increase in full width half maximum (FWHM) of the spectral response function, and a commensurate reduction in spectral resolution. Accordingly, maintaining a suitably high spectral resolution in a prior art spectrometer 204 results in a decrease in sensitivity or optical throughput.

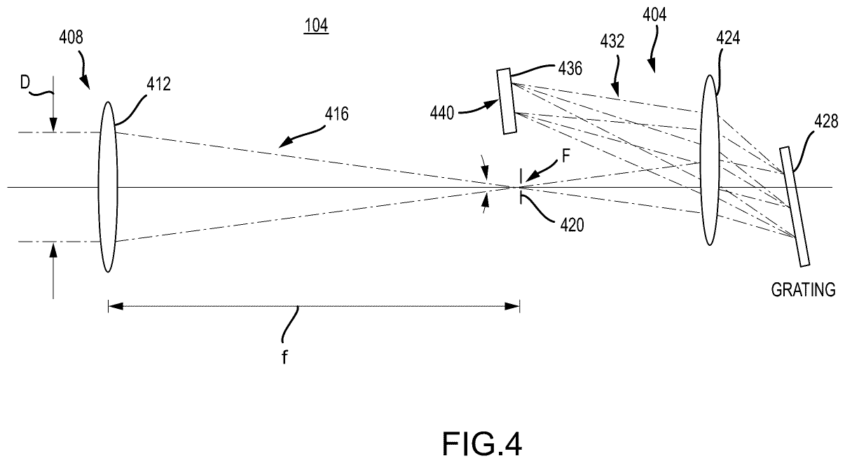

An optical sensor system 104 incorporating a magnifying spectrometer 404 in accordance with embodiments of the present disclosure and an associated objective optic or telescope 408 is depicted in FIG. 4. Similar to the prior art arrangement, light 416 collected by the telescope 408 (hereinafter referred to as collected light 416) is focused by an objective lens system 412 at an entrance slit 420 of the magnifying spectrometer 404. A spectrometer lens system 424 receives collected light 416 that has passed through the entrance slit 420, and focuses or reimages that collected light 416 onto a diffraction or dispersing element 428. As examples, the dispersing element 428 can be implemented as a diffraction grating or a prism. Light dispersed or diffracted by the dispersing element 428 (hereinafter referred to as dispersed light 432) is then focused onto a focal plane array 436 of a detector 440 by the spectrometer lens system 424. Also similar to the prior art arrangement, components of the dispersed light 432 originating from different locations in the cross track direction 124 within the field of view 120 of the optical sensor system 104 will be incident on different rows (or columns) of pixels of the focal plane array 436 and will be incident on different columns (or rows) of pixels of the focal plane array 436 of the detector 440 based on the wavelength of the collected light 416. However, in a magnifying spectrometer 404 in accordance with embodiments of the present disclosure, a dimension of the reimaged pupil diameter in the cross track direction received at the dispersing element 428 will be larger than the size of the image of the entrance slit 420 at the focal plane array 436 of the detector 440. More particularly, a width of the reimaged entrance slit at the focal plane array 436 is less than a width of the entrance slit 420 itself. This difference in size is enabled by configuring the spectrometer lens system 424 to provide a magnification of greater than 1.0λ.

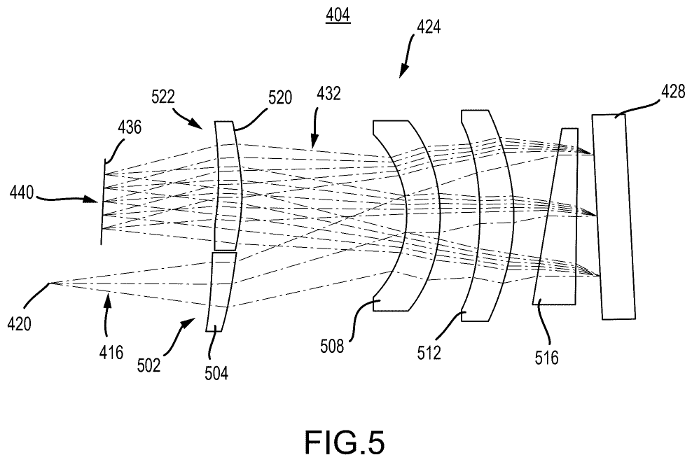

Additional details of a magnifying spectrometer 404 in accordance with embodiments of the present disclosure are depicted in FIG. 5. As shown, the spectrometer lens system 424 can include multiple elements. For instance, the spectrometer lens system 424 can include a first lens 504, a second lens 508, a third lens 512, a compensating prism 516, and a fourth lens 520. The collected light 416 passed through the entrance slit 420 is focused onto the dispersing element 428 by a first set of elements 502 of the spectrometer lens system 424. In this example, the first set of elements 502 includes the first lens 504, the second lens 508, the third lens 512, and the compensating prism 516. In particular, the light passed through the entrance slit 420 is received by the first lens 504, the second lens 508, the third lens 512, and the compensating prism 516, in that order, and is thereby focused onto the dispersing element 428. The collected light 416 is dispersed or diffracted by the dispersing element 428 and is passed focused onto the focal plane array 436 of the detector 440 by a second set of elements 522 of the spectrometer lens system 424. In the example magnifying spectrometer 404 depicted in FIG. 5, the second set of elements 522 includes the compensating prism 516, the third lens 512, the second lens 508, and the fourth lens 520. The dispersed light 432 in this example is passed to the compensating prism 516, the third lens 512, the second lens 508, and the fourth lens 520, in that order, and is thereby focused onto the focal plane array 436 of the detector 440. Accordingly, in this example, the first set of elements 502 of the spectrometer lens system 424 through which the collected light 416 is passed is different than the second set of elements 522 of the spectrometer lens system 424 through which the dispersed light 432 is passed. In particular, in this example, the first lens 504 is unique to the first set of elements 502, the fourth lens 520 is unique to the second set of elements 522, and the second lens 508, the third lens 512, and the compensating prism 516 are shared by the first set of elements 502 and the second set of elements 522. In accordance with embodiments of the present disclosure, by providing a first lens 504 having a first focal length through which the collected light 416 is passed (but through which the dispersed light 432 is not passed), and a fourth lens 520 having a second focal length through which the dispersed light 432 is passed (but through which the collected light 416 does not pass prior to becoming dispersed light 432), a magnification can be applied within the magnifying spectrometer 404. As can be appreciated by one of skill in the art after consideration of the present disclosure, the first set of elements 502 and the second set of elements 522 need not share any elements of the spectrometer lens system 424.

As an example of a configuration of an optical sensor system 104 including a magnifying spectrometer 404 in accordance with embodiments of the present disclosure, the telescope 408 has an entrance pupil diameter D of 240 mm and an objective lens system 412 having a focal length f of 921 mm, and is configured to produce a reimaged pupil diameter of about 55 mm, thereby providing a telescope 408 magnification of about 4.4λ. The entrance slit 420 has a length of 55 mm and a width of 0.050 mm. The spectrometer lens system 424 is configured to provide 1:1.4 magnification within the spectrometer 404. This produces a slit image at the focal plane array 436 with a maximum dimension of about 39 mm. Therefore, in this example, a magnifying spectrometer 404 in accordance with embodiments of the present disclosure can produce an image at the focal plane array 436 that is the same size as in the example prior art spectrometer 204 discussed above, but enables the width of the entrance slit 420 to be larger than the width of the entrance slit 220 of the prior art spectrometer 204. For instance, in the particular examples of FIGS. 3 and 5, the width of the entrance slit 420 of the magnifying spectrometer 404 is approximately twice as large as the width of the entrance slit 220 of the prior art spectrometer 204. As a result, a magnifying spectrometer 404 in accordance with embodiments of the present disclosure can provide increased optical throughput for an equivalent spectral and spatial resolution as compared to a prior art spectrometer 204.

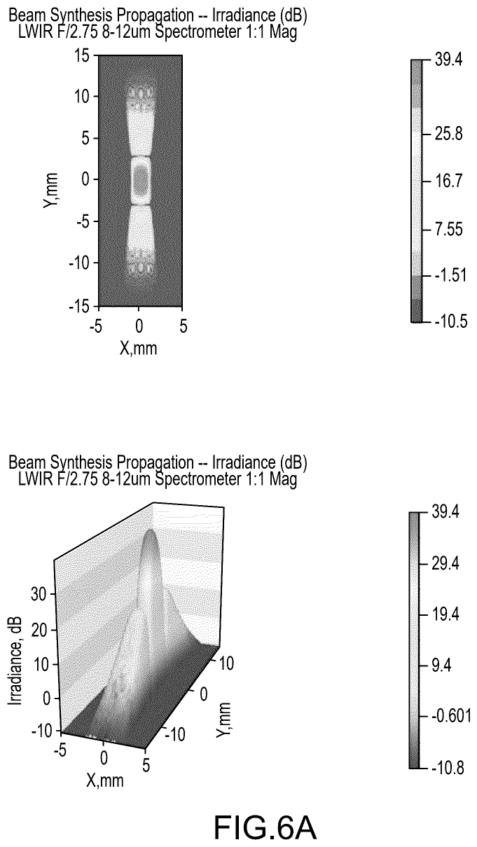

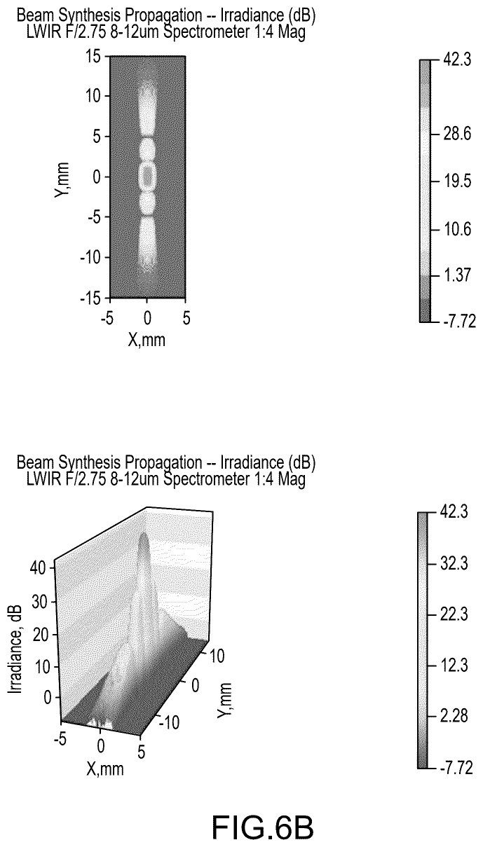

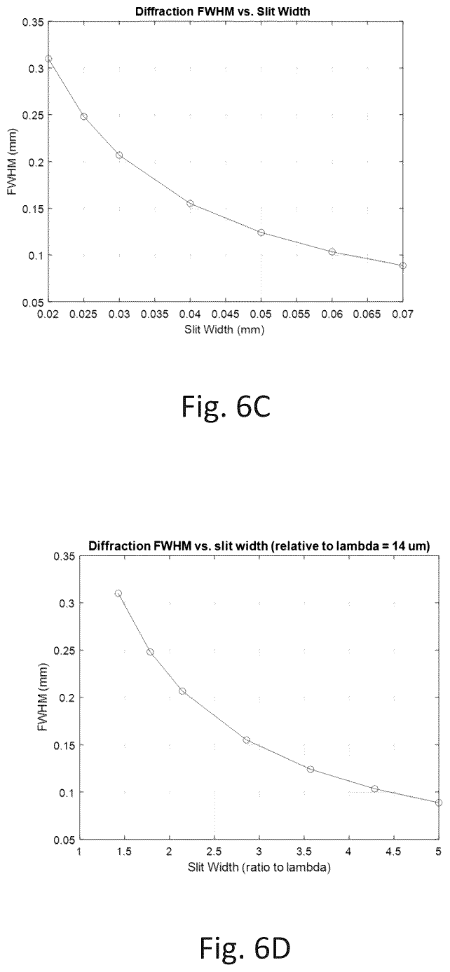

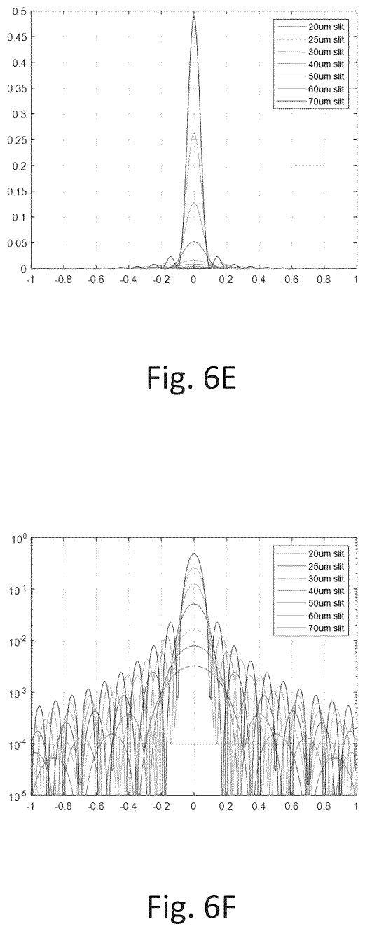

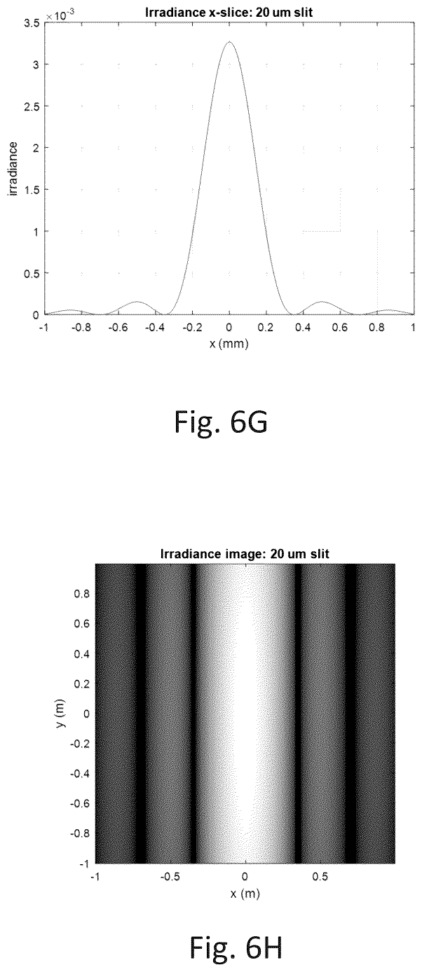

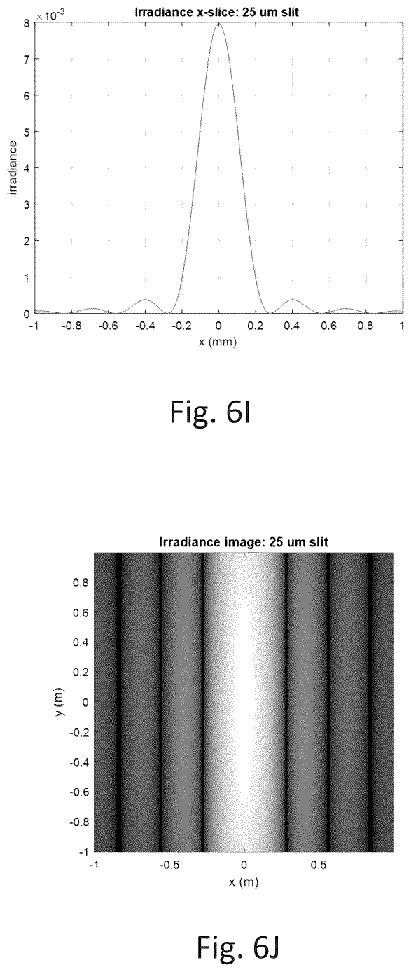

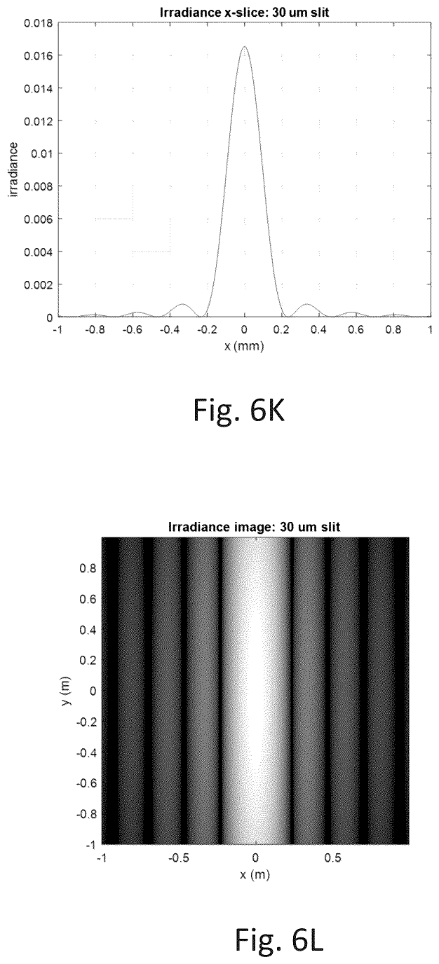

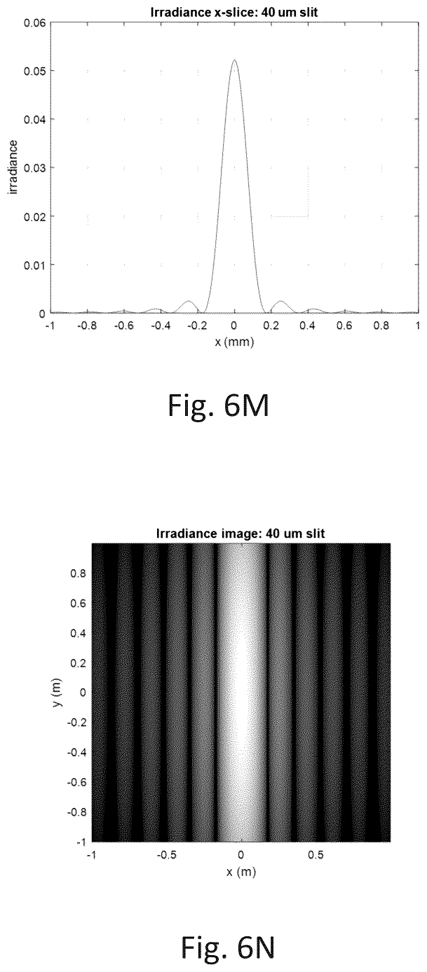

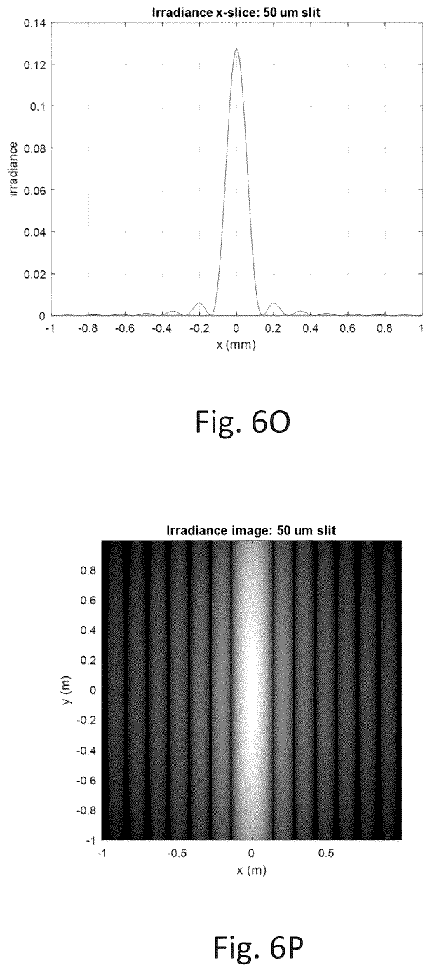

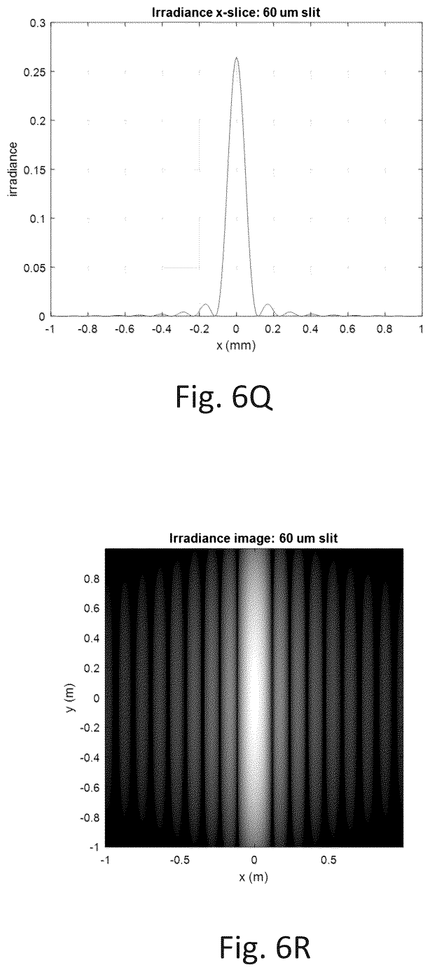

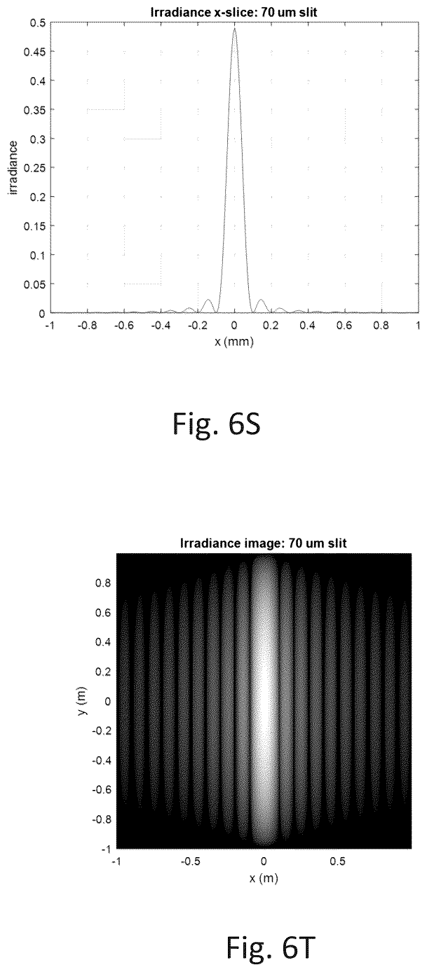

The performance of an example prior art spectrometer 204 as compared to a magnifying spectrometer 404 as disclosed herein is depicted in FIGS. 6A-6B. More particularly, the irradiance on a dummy surface located 5 mm behind the spectrometer entrance slit 220 of a prior art spectrometer 204 is depicted in FIG. 6A, while the irradiance on a dummy surface located 5 mm behind the spectrometer entrance slit 420 of a magnifying spectrometer 404 as disclosed herein is depicted in FIG. 6B. These figures show a broadening of the central peak and more energy located in the wings of the irradiance pattern for the prior art spectrometer 204 as compared to the magnifying spectrometer 404 in accordance with embodiments of the present disclosure. The magnifying spectrometer 404 therefore provides more energy to the detector 440, resulting in improved optical throughput as compared to a prior art spectrometer 204 having the same or nearly the same entrance pupil diameters D and fields of view 120.

The irradiance due to diffraction by a slit can be calculated using the Fraunhofer diffraction equation:

$$I ( x , y ) = ( w \hat{} 2 / λ z ) \hat{} 2 [ ( J\_ 1 ( 2 π w / λ z √ ( x \hat{} 2 + y \hat{} 2 ) ) ) / ( w / λ z √ ( x \hat{} 2 + y \hat{} 2 ) ) ] \hat{} 2$$

Where:
w is the half width of a square aperture in the source plane, or the radius of a circular aperture
x, y are the coordinates in the observation plane,
λ is the wavelength of light,
z is the distance from the source to the observation plane, and
J1 is the 1st-order Bessel function.

The variation in illumination due to differences in the width of the entrance slit is depicted in FIGS. 6C-6T. More particularly, FIG. 6C illustrates diffraction FWHM versus slit width; FIG. 6D illustrates diffraction FWHM versus slit width as a function of the wavelength of the incident light (here 14 micron); FIG. 6E illustrates peak irradiance at different entrance slit widths; FIG. 6F illustrates peak irradiance at different entrance slit widths (Log₁₀ Y-axis); FIGS. 6G-6H illustrate irradiance for a 20 μm entrance slit width; FIGS. 6I-6J illustrate irradiance for a 25 μm entrance slit width; FIGS. 6K-6L illustrate irradiance for a 30 μm entrance slit width; FIGS. 6M-6N illustrate irradiance for a 40 μm entrance slit width; FIGS. 6O-6P illustrate irradiance for a 50 μm entrance slit width; FIGS. 6Q-6R illustrate irradiance for a 60 μm entrance slit width; and FIGS. 6S-6T illustrate irradiance for a 70 μm entrance slit width.

In the examples of FIGS. 2-5, the detectors 240 and 440 may be identical to one another. Where the detectors 240 and 440 include 4 k×4 k focal plane arrays 236 and 436 having a 10 μm pixel pitch, the area of each of the focal plane arrays 236 and 436 is about 40 mm by 40 mm. The respective telescopes 208 and 408 have the same entrance pupil diameter D. However, in order to maintain the same field of view between the example prior art spectrometer 204 having unit magnification and the example magnifying spectrometer 404 having a magnification of 1.4×, the focal lengths of the respective telescopes 208 and 408 differ. Also, the light incident surface of the dispersing element 228 included in the prior art spectrometer 204 can be smaller than an otherwise equivalent dispersing element 428 included in the magnifying spectrometer 404. The magnification internal to the magnifying spectrometer 404 as disclosed herein enables the width of the entrance slit 420 to be larger than the width of the entrance slit 220 of the prior art spectrometer 204, while allowing the image size of the entrance slit 420 at the focal plane array 436 to be the same as the image size of the entrance slit 220 at the focal plane array 236, for a given entrance pupil diameter D and a given field of view 120. That is, embodiments of the present disclosure enable the use of an entrance slit 420 having a width that is greater than a distance corresponding to 2 to 3 adjacent pixels in width, decreasing the diffraction of long wavelength light at the entrance slit 420, while maintaining high spectral resolution by producing a slit image at the focal plane array 436 of the detector 440 that is about the same as the distance corresponding to 2 to 3 pixels in width.

Another example configuration of a magnifying spectrometer 404 in accordance with embodiments of the present disclosure is set forth in Table 1.

TABLE 1
Parameters for Candidate LWIR Imaging
Spectrometer with magnification

| Parameter | Value | Units |
|---|---|---|
| Instrument focal length | 658 mm | mm |
| System F/# | 2.75 | |
| Entrance pupil diameter | 240.2 mm | mm |
| Telescope magnification | 4.5 | |
| Reimaged pupil diameter | 53.37 | mm |
| Spectral band | 8.0-12.0 | μm |
| Tele/Objective focal | 204.67 | mm |
| length @ slit | | |
| F/# at slit | 3.83 | |
| Field of view | 3.48 | degrees |
| Detector pixel pitch | 0.010 | mm |
| Number of spatial pixels | 3905 | pixels |
| Number of spectral pixels | 3200 | pixels |
| Spectral sampling | 1.25 | nm/pixel |
| Dispersion length | 32.0 | mm |
| Spectrometer magnification | 1.4 | |
| Slit length | 54.67 | mm |
| Slit width | 0.035 | mm |
| FPA x-track image size | 39.05 | mm |
| FWHM @ FPA (slit image) | 0.025 | mm |

As in the previous example, magnification by the spectrometer lens system 424 in this example results in a reimaged pupil diameter at the dispersing element 428 that is larger than the image size at the focal plane array 436 of the detector 440. This in turn allows the use of an entrance slit 420 having a width that is greater than would otherwise be required in order to maintain a high spectral resolution. This greater entrance slit 420 width enables the optical throughput of the magnifying spectrometer 404 to be higher than that of a prior art spectrometer 204 when used with telescopes 208 and 408 having the same entrance pupil diameter D and field of view 120, and when used with the same focal plane array 236 and 436 dimensions and pixel configuration.

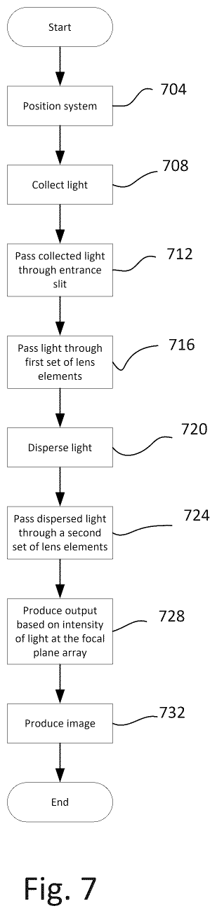

With reference now to FIG. 7, a process for obtaining spectrally resolved images is depicted. For instance, images with spectral information spanning a selected wavelength range, such as from 8 μm to 12 μm can be obtained. Initially, at step 704, an optical sensor system 104 including a magnifying spectrometer 404 is positioned such that a field of view 120 of the optical sensor system 104 encompasses a portion of an object or an area of interest 112. Light 416 is then collected by a telescope 408 included in the optical sensor system 104 from within the field of view 120 (step 708). The collected light 416 is passed through an entrance slit 420 positioned at the focal point of the telescope 408 (step 712). After passing through the entrance slit 420, the collected light 416 is passed through a first set of elements included in a spectrometer lens system 424 and is focused onto a dispersing element 428 (step 716). The dispersing element 428 disperses the collected light 416, forming dispersed light 432 (step 720). The dispersed light 432 is passed through a second set of elements included in the spectrometer lens system 424 and is focused or reimaged onto a focal plane array 436 of the detector 440 (step 724). The combined effect of the first and second sets of elements included in the spectrometer lens system 424 is to apply a magnification to the collected light 416, resulting in a reimaged pupil diameter at the dispersing element 428 that is larger than the largest dimension of the image of the entrance slit 420 at the focal plane array 436. Moreover, a width of the reimaged entrance slit at the focal plane array 436 is less than a width of the entrance slit itself 420. This magnification internal to the spectrometer 404 in turn enables the entrance slit 420 to have a width that is greater than a width equivalent to a distance spanning 2 to 3 pixels of the focal plane array 436. The detector 440 can then produce an output based on an intensity of light received at each of the pixels of the focal plane array 436 (step 728), with each row of pixels corresponding to a different location within the field of view 120, and with each column of pixels corresponding to a different wavelength component with the collected light 416. The output of the detector 440 can then be processed to produce an image (step 732). For example, the output of the detector 440 obtained from images 132 obtained from each of a number of fields of view 120 can be combined to produce a two-dimensional image 136 of the area of interest 112 for each of a number of wavelengths. The process can then end.

Although particular examples of magnifying spectrometers 404 in accordance with embodiments of the present disclosure have been provided for purposes of illustration and description, it should be appreciated that other configurations are possible. Accordingly, a magnifying spectrometer 404 is not limited to such examples. For instance, although various examples have been provided in which a magnification within the magnifying spectrometer 404 of about 1.4× is supplied by the spectrometer lens system 424, any magnification amount greater than 1.0× is encompassed by the present disclosure. In addition, it should be appreciated that the spectrometer lens system 424 can provide a magnification of greater than 1.4λ. For instance, ever larger magnifications, such as a magnification of 1.5λ, 2.0× or even greater can usefully be applied as focal plane arrays 436 having ever smaller pixel pitches become available. In accordance with at least some embodiments of the present disclosure, the provided magnification enables a width of the entrance slit 420 to be at least two times greater than a width of an image of the entrance slit 420 at the focal plane array 236 of the detector 440. In accordance with still other embodiments of the present disclosure, the provided magnification enables a width of the entrance slit 420 to be at least three times greater than a wavelength of light at a longest operating wavelength of the magnifying spectrometer 404.

In addition, although examples of a magnifying spectrometer 404 having a Littrow configuration have been illustrated, it should be appreciated that embodiments of the present disclosure are not limited to any particular configuration. In addition, the example lens system 424 configuration has been provided for explanatory purposes, but is not intended to be limiting. In particular, a magnifying spectrometer 404 as disclosed herein can have any combination of lens system 424 elements, such as but not limited to refracting lenses, mirrors, prisms, or the like. In addition, the dispersing element 428 can include a diffraction grating, prism, or other element capable of separating light by wavelength. In addition, different sets of elements of a lens system 424 need not share one or more elements.

The foregoing disclosure has been presented for purposes of illustration and description. Further, the description is not intended to limit the disclosure to the form disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosure and to enable others skilled in the art to utilize the disclosure in such or in other embodiments and with the various modifications required by their particular application or use of the disclosure. It is intended that the appended claims be construed to include alternative embodiments to the extent permitted by the prior art.

What is claimed is:

1. A spectrometer, comprising:
an entrance slit;
a lens system;
a dispersing element; and
a detector,
wherein the lens system images light passed through the entrance slit onto the dispersing element,
wherein the lens system images light dispersed by the dispersing element onto the detector, and
wherein a dimension of the imaged light at the dispersing element is greater than a dimension of the image at the detector.

2. The spectrometer of claim 1, wherein the lens system magnifies the light passed through the entrance slit.

3. The spectrometer of claim 1, wherein the entrance slit has a width and a length, and wherein the width of the entrance slit is greater than a width of an image of the entrance slit at the detector.

4. The spectrometer of claim 1, wherein the entrance slit has a width and a length, and wherein the width of the entrance slit is at least two times greater than a width of an image of the entrance slit at the detector.

5. The spectrometer of claim 1, wherein the entrance slit has a width and a length, and wherein the width of the entrance slit is at least 3 times a wavelength of light at a longest operating wavelength of the spectrometer.

6. The spectrometer of claim 1, wherein the lens system includes a plurality of elements, wherein at least a first element included in the plurality of elements of the lens system receives the light passed through the entrance slit but does not receive the light dispersed by the dispersing element.

7. The spectrometer of claim 1, wherein the lens system includes a plurality of elements, wherein at least a first element included in the plurality of elements of the lens system receives the light passed through the entrance slit prior to that light reaching the dispersing element but does not receive the light dispersed by the dispersing element, and wherein at least a second element included in the plurality of elements of the lens system receives the light dispersed by the dispersing element but does not receive the light passed through the entrance slit prior to that light reaching the dispersing element.

8. The spectrometer of claim 1, wherein the spectrometer has a Littrow configuration.

9. The spectrometer of claim 1, wherein the dispersing element is a diffraction grating.

10. The spectrometer of claim 1, wherein the dispersing element is a prism.

11. The spectrometer of claim 1, wherein the detector includes a focal plane array.

12. The spectrometer of claim 1, wherein the detector includes a focal plane array having a plurality of rows of pixels and a plurality of columns of pixels, wherein the dispersed light is incident on a first one of different rows or columns of pixels based on a location within a field of view from which the dispersed light was collected, and wherein the dispersed light is incident on a second one of different rows or columns based on a wavelength of the collected light.

13. The spectrometer of claim 1, wherein the dispersed light imaged onto the detector includes wavelengths of from 8 μm to 12 μm, and wherein a width of the entrance slit is at least 35 μm.

14. The spectrometer of claim 1, wherein the lens system magnifies the light passed through the entrance slit by greater than 1.1λ.

15. The spectrometer of claim 1, wherein the lens system magnifies the light passed through the entrance slit by 1.4× or more.

16. An optical sensor system, comprising:
a telescope; and
a magnifying spectrometer, including:
an entrance slit, wherein light collected by the telescope is focused at the entrance slit;
a dispersing element;
a detector having a plurality of pixels disposed in an array; and
a lens system, wherein light passed by the entrance slit is reimaged by the lens system onto a surface of the dispersing element, wherein light dispersed by the dispersing element is focused onto the array of pixels, wherein a diameter of the light reimaged onto the surface of the dispersing element is greater than a diameter of the light at the detector.

17. The optical sensor system of claim 16, wherein the lens system magnifies the light collected by the telescope.

18. The optical sensor system of claim 16, wherein width of the entrance slit is greater than a distance equivalent to a span of 3 adjacent pixels of the detector.

19. A method for obtaining spectrally resolved image, comprising:
collecting light from an area of interest;
passing the collected light through an entrance slit, wherein the entrance slit has a width that is equal to or greater than three times a selected wavelength;
dispersing the light passed through the entrance slit; and
reimaging the entrance slit at a focal plane of a detector, wherein a width dimension of the reimaged entrance slit at the focal plane of the detector is less than a width dimension of the entrance slit itself.

20. The method of claim 19, wherein the width of the entrance slit itself is at least 1.4× greater than the width of the reimaged entrance slit at the focal plane of the detector.
